(19) United States
(12) Patent Application Publication
(10) Pub. No.: US 2013/0076106 A1
(43) Pub. Date: Mar. 28, 2013

(54) NON-ROTATING WHEEL COVER ASSEMBLY WITH UNIVERSAL LUG MOUNTING BRACKET

(71) Applicants: Thomas J. Mooney, Naples, FL (US); William J. Brown, Fort Myers, FL (US)

(72) Inventors: Thomas J. Mooney, Naples, FL (US); William J. Brown, Fort Myers, FL (US)

(21) Appl. No.: 13/244,315

(22) Filed: Sep. 24, 2011

(51) Int. Cl. B60B 7/20

(52) U.S. Cl. 301/37.25

(57) ABSTRACT

A non-rotating wheel cover assembly (1) that attaches to a wheel via an universal lug mounting bracket (2). The universal lug mounting bracket is made up of a preferably circular mounting plate (4) having a plurality of slots (24) extending from a central aperture (14) to an outer edge (35) of the mounting plate. The slots are positioned around the mounting plate to accommodate various lug patterns, such as wheels having five lugs (3) or six lugs. The slots also accommodate wheels having various diameters where the lugs are spaced further or closer to the center of a wheel. An inner plate (10) having a bearing (17) located therein engages an axle (18) extending from an outer plate (20). A ridge (23) located at a base (24) of the axle prevents damage to a wheel cover (8) if the wheel cover comes into contact with a curb.

### BACKGROUND OF THE INVENTION

This invention relates to commercial and non-commercial display wheel covers, and more particularly to non-rotating wheel covers that mount to wheels by extended lug nuts and a universal lug mounting bracket that mounts on various lug patterns and wheel diameters.

Conventional wheel covers include hubcaps that attach to an outer edge of a wheel rim. Such conventional wheel covers rotate with the wheel. Improvements to such conventional wheel covers include adding advertising or other non-commercial designs, such as sports logos. However, the designs can only be seen properly while the wheels are at rest and not while the wheels are rotating. There have been attempts to develop non-rotating wheel covers that allow designs on the covers to be seen while a vehicle is in motion and the wheels are rotating. However, prior non-rotating wheel covers have been prone to failure due to the design and structure of the brackets used to attach the wheel covers to the wheels, especially if the wheel cover comes into contact with a curb or other object. This is especially of concern due to the danger a wheel cover can pose if it comes off of a wheel while a vehicle is in motion. Another drawback of prior non-rotating wheel covers is that the brackets were not universal and thus, multiple sized brackets were needed for wheels having different lug patterns and diameters. An even further problem with conventional non-rotating wheel covers is the excessive time it takes to change out covers. This is especially important for commercial covers used on vehicles such as taxi cabs, where the taxi cabs cannot be kept off the road for an extensive period of time to change the covers from one advertiser to another advertiser.

Therefore, a need exists for a non-rotating wheel cover having a universal lug mounting bracket that securely holds the cover to a wheel, fits any sized lug pattern or lug diameter and that can be removed and installed quickly.

The relevant prior art includes the following references:

| | | |
|---|---|---|
| Patent No. | Inventor | Issue/Publication Date |

(U.S. Patent References)

| | | |
|---|---|---|
| 7,014,273 | Yang et al. | Mar. 21, 2006 |
| 6,983,998 | Litzka | Jan. 10, 2006 |
| 2005/0062336 | Rutterman | Mar. 24, 2005 |
| 2005/0062339 | Fitzgerald | Mar. 24, 2005 |
| 6,857,709 | McLean et al. | Feb. 22, 2005 |
| 2005/0035651 | Hsiao | Feb. 17, 2005 |
| 2004/0232757 | Hsien-Yu | Nov. 25, 2004 |
| 6,655,061 | Good | Dec. 02, 2003 |
| 6,536,848 | Goodman | Mar. 25, 2003 |
| 6,443,529 | Williams | Sep. 03, 2002 |
| 6,309,027 | Smith | Dec. 30, 2001 |
| 6,120,104 | Okamoto et al. | Sep. 19, 2000 |
| 5,931,543 | Smith | Aug. 03, 1999 |
| 5,659,989 | Hsiao et al. | Aug. 26, 1997 |
| 5,588,715 | Harlen | Dec. 31, 1996 |
| 5,509,725 | Chiu | Apr. 23, 1996 |
| 5,190,354 | Levy et al. | Mar. 02, 1993 |
| 2,548,070 | Ryan | Apr. 10, 1951 |

(Foreign Patent References)

| | | |
|---|---|---|
| EP1053893 | Kupfer et al. | Nov. 22, 2000 |

### NON-PATENT REFERENCES

HALL, STEVE, “AdFleet Launches ‘Wheelvertising’,” Jul. 7, 2004, www.adrants.com
MEXACO, LTD., “website printout,” www.capads.com
RIGIDISC-MEDIA, INC., “Instructions for Device Having Fixing Cap”
RIGIDISC-MEDIA, INC., “Instructions for Device Having Expansion Ring”
RIGIDISC-MEDIA, INC., “Mounting Instructions for Segway i180”
RIGIDISC-MEDIA, INC., “Mounting Instructions for Segway i2”
RIGIDISC-MEDIA, INC., “Instructions for Device Having Retension Ring and/or Mounting Clips”

### SUMMARY OF THE INVENTION

The primary object of the present invention is to provide a non-rotating wheel cover assembly having a universal lug mounting bracket that securely holds the wheel cover to a wheel.

Another object of the present invention is to provide a non-rotating wheel cover assembly having a universal lug mounting bracket that fits any sized lug pattern or wheel diameter.

A further object of the present invention is to provide a non-rotating wheel cover assembly having a universal lug mounting bracket that allows a user to easily change wheel covers.

Another object of the present invention is to provide a non-rotating wheel cover assembly having a universal lug mounting bracket that prevents damage when the wheel cover makes contact with a street curb.

A further object of the present invention is to provide a non-rotating wheel cover assembly having a universal lug mounting bracket that is weatherproof.

The present invention fulfills the above and other objects by providing a non-rotating wheel cover assembly that attaches to lugs of a vehicle using a universal lug mounting bracket. The universal lug mounting bracket is made up of a preferably circular mounting plate having a plurality of slots extending from a central point to an outer edge of the mounting plate. The slots are positioned around the mounting plate to accommodate various lug patterns, such as wheels having five lugs or six lugs. The slots also accommodate wheels having various diameters where the lugs are spaced further from or closer to the center of the wheel. The mounting plate is secured to lugs of a wheel using extended lug nuts having a threaded aperture at one end to accommodate the lugs and a threaded aperture at the opposite end to accommodate an attachment means, such as a bolt. An inner plate having a central portion that extends outward to create a ridge that rests against the front surface of the mounting plate while the central portion rests inside a central aperture located on the mounting plate. The inner plate is attached to the mounting plate via at least one attachment means, such as a screw, bolt and so forth. The central portion of the inner plate is hollowed out to create a cup that a bearing rests in. An axle extending from a central portion of an outer plate extends through an aperture located on a front surface of the inner plate and into the bearing. A ridge located at a base of the axle prevents the front surface of the inner plate from coming into contact with a rear surface of the outer plate, thereby preventing rubbing and damage to the wheel cover if the wheel cover comes into contact with a curb. At least two apertures are preferably located on a front surface of the outer plate for engaging at least two posts located on a rear surface of the wheel cover, thereby allowing for easy alignment and installation of the wheel cover on the outer plate during installation. The wheel cover is attached to the outer plate via an attachment means, such as a bolt, that passes through an aperture located at the center of the wheel cover and into a threaded aperture located in the center of the outer plate and axle. A weight is preferably located on the rear surface of the wheel cover to further prevent the wheel cover from rotating while the wheel is in motion. An outer edge of the wheel cover may be beveled.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side exploded plan view of a non-rotating wheel cover assembly having a universal lug mounting bracket of the present invention;

FIG. 2 is a side view of an assembled non-rotating wheel cover assembly having a universal lug mounting bracket of the present invention;

FIG. 3 is a front view of a mounting plate of a universal lug mounting bracket of the present invention showing the preferred location of slots on the mounting plate;

FIG. 4 is a front plan view of a mounting plate of a universal lug mounting bracket of the present invention mounted to a five lug pattern having a short diameter between the lugs; and

FIG. 5 is a front plan view of a mounting plate of a universal lug mounting bracket of the present invention mounted to a six lug pattern having a short diameter between the lugs

### DESCRIPTION OF THE PREFERRED EMBODIMENTS

For purposes of describing the preferred embodiment, the terminology used in reference to the numbered accessories in the drawings is as follows:
1. non-rotating wheel cover assembly
2. universal lug mounting bracket
3. lug
4. mounting plate
5. extended lug nut
6. lug threaded aperture
7. bolt threaded aperture
8. wheel cover
9. bolt
10. inner plate
11. central portion of inner plate
12. ridge along outer perimeter of inner plate
13. front surface of mounting plate
14. central aperture on mounting plate
15. aperture on mounting plate
16. threaded aperture on inner plate
17. bearing
17a. central aperture of bearing
18. axle
19. central portion of outer plate
20. outer plate
21. aperture on front surface of inner plate
22. front surface of inner plate
23. ridge located on axle
24. base of axle
25. rear surface of outer plate
26. aperture on outer plate
27. front surface of outer plate
28. post
29. rear surface of wheel cover
30. aperture on wheel cover
31. threaded aperture on outer plate
32. weight
33. outer edge of wheel cover
34. slot
35. outer edge of mounting plate
36. first slot
37. 0 degrees
38. second slot
39. 60 degrees
40. third slot
41. 90 degrees
42. fourth slot
43. 145 degrees
44. fifth slot
45. 180 degrees
46. sixth slot
47. 215 degrees
48. seventh slot
49. 270 degrees
50. eighth slot
51. 300 degrees

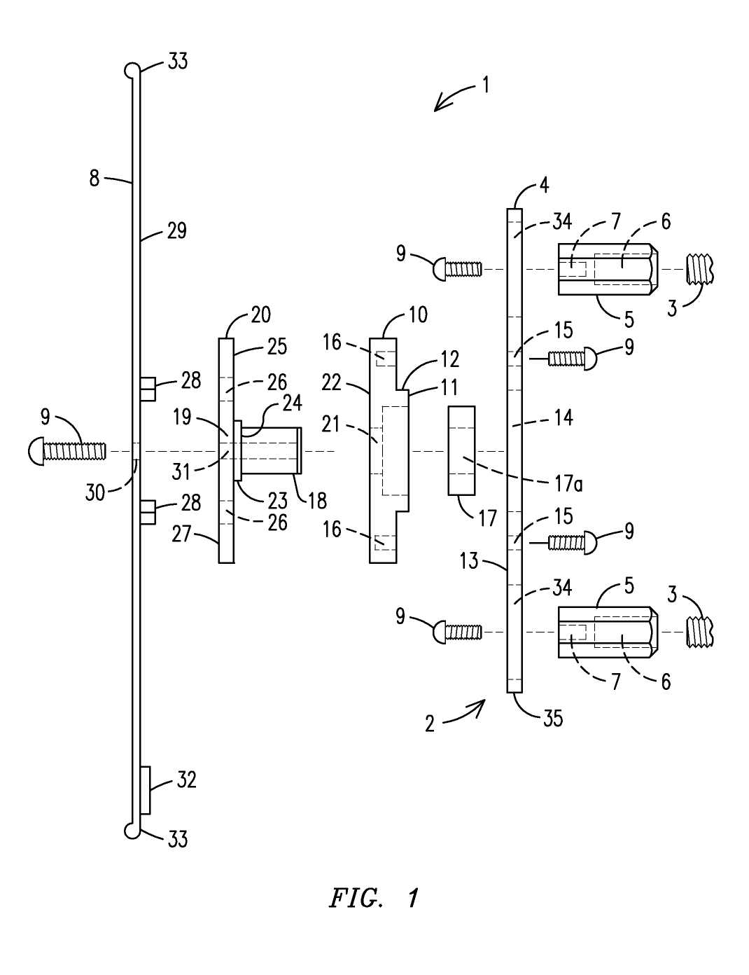

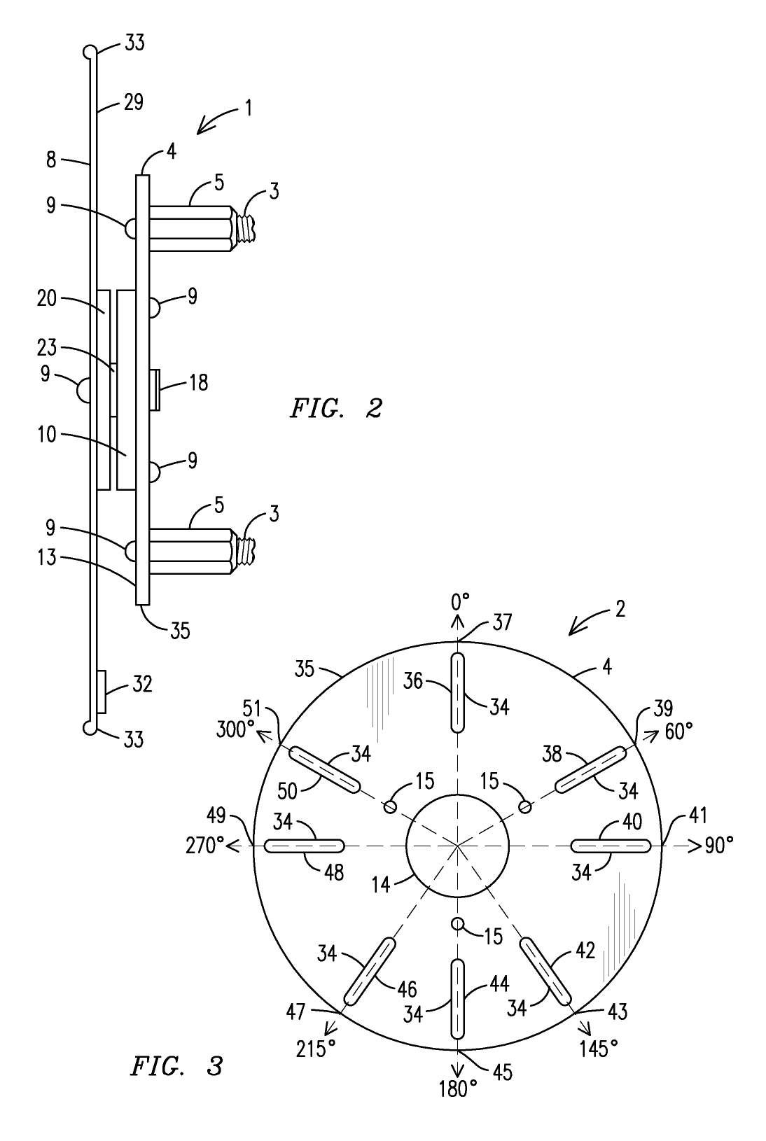

With reference to FIGS. 1 and 2, a side exploded plan view and a side view, respectively, of a non-rotating wheel cover assembly 1 having a universal lug mounting bracket 2 of the present invention is illustrated. The non-rotating wheel cover 1 attaches to lugs 3 on a wheel of a vehicle using the universal lug mounting bracket 2. The universal lug mounting bracket 2 comprises a preferably circular shaped mounting plate 4. The mounting plate 4 is secured to the lugs 3 by extended lug nuts 5 having a lug threaded aperture 6 at one end to accommodate the lugs 3 and a bolt threaded aperture 7 at the opposite end to accommodate a bolt 9. An inner plate 10 having a central portion 11 that extends outward to create a ridge 12 around an outer perimeter of the inner plate 10 rests against an front surface 13 of the mounting plate 4 while the central portion 11 rests inside a central aperture 14 located on the mounting plate 4, as illustrated further in FIGS. 3-6. The inner plate 10 is attached to the mounting 4 via at least one bolt 9, that passes through at least one aperture 15 located on the mounting plate 4 and engages at least one threaded aperture 16 located on the inner plate 10. The central portion 11 of the inner plate 10 is hollowed out to accept a bearing 17 having a central aperture 17a. An axle 18 extending from a central portion 19 of an outer plate 20 extends through an aperture 21 located on a front surface 22 of the inner plate 10 and into the bearing 17. The axle 18 remains stationary within the bearing 17 while the inner plate 10 and mounting plate 4 rotate with a rotating wheel. A ridge 23 located at a base 24 of the axle 18 prevents the front surface 22 of the inner plate 10 from coming into contact with an rear surface 25 of the outer plate 20, thereby preventing rubbing and damage to a wheel cover 8 if the wheel cover 8 comes into contact with a curb. At least two apertures 26 are preferably located on a front surface 27 of the outer plate 20 for engaging at least two posts 28 located on an rear surface 29 of the wheel cover 8, thereby allowing for easy alignment and installation of the non-rotating wheel cover 8 on the outer plate 20 during installation. The wheel cover 8 is attached to the outer plate 20 by at least one bolt 9, that passes through an aperture 30 located at the center of the wheel cover 8 and into a threaded aperture 31 located in the center of the outer plate 20 and axle 18. A weight 32 is preferably located on the rear surface 29 of the wheel cover 8 to further prevent the wheel cover 8 from rotating. An outer edge 33 of the wheel cover 8 may have a bevel 34.

With reference to FIG. 3, a front view of a mounting plate 4 of a universal lug mounting bracket 2 of the present invention showing the preferred location of slots 34 on the mounting plate 4 is illustrated. The mounting plate 4 is preferably circular and comprises a plurality of slots 34 extending from the central aperture 14 to an outer edge 35 of the mounting plate 4. The slots 34 are positioned around the lug beginning with a first slot 36 extending to a top of the mounting plate 4 at 0 degrees 37. A second slot 38 is at an angle of 60 degrees 39 in relation to the first slot 36. A third slot 40 is at an angle of 90 degrees 41 in relation to the first slot 36. A fourth slot 42 is at an angle of 145 degrees 43 in relation to the first slot 36. A fifth slot 44 is at an angle of 180 degrees 45 in relation to the first slot 36. A sixth slot 46 is at an angle of 215 degree 47 in relation to the first slot 36. A seventh slot 48 is at an angle of 270 degrees 49 in relation to the first slot 36. An eighth slot 50 is at an angle of 300 degree 51 in relation to the first slot 36. Apertures 15 are located on the mounting plate 4 for attaching the mounting plate 4 to an inner plate 10 by bolts 9, as illustrated in FIGS. 1 and 2.

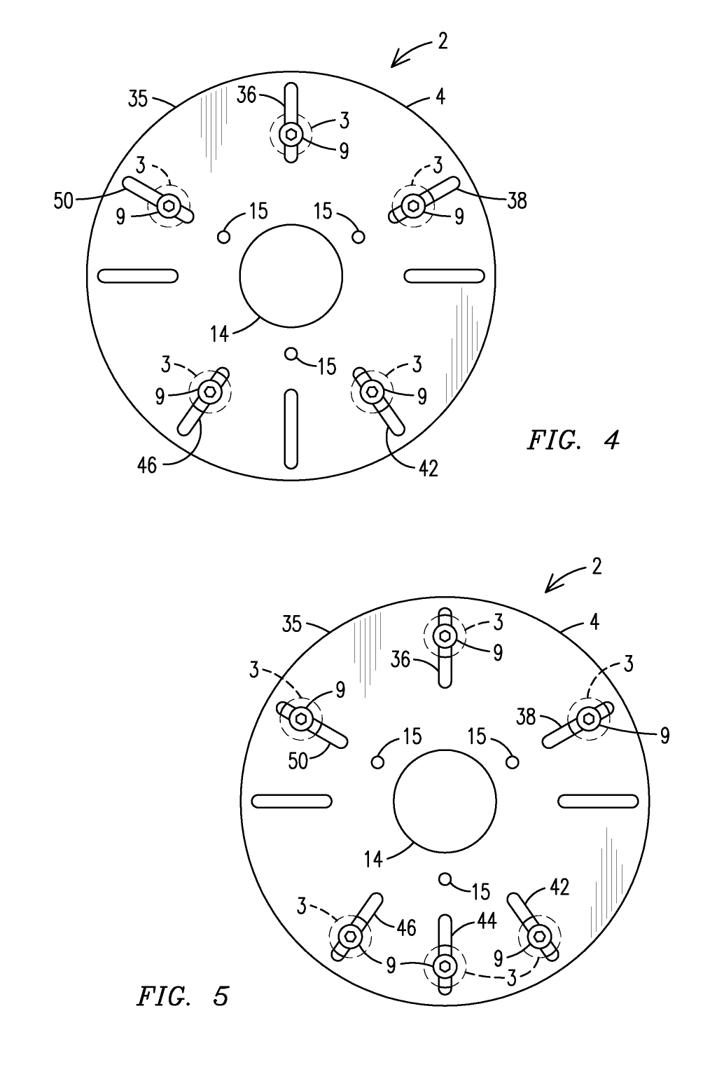

With reference to FIG. 4, a front plan view of a mounting plate 4 of a universal mounting plate 2 of the present invention mounted to a five lug pattern having a short diameter between the lugs 3 is illustrated. The lugs 3 are mounted on slots one 36, two 38, four 42, six 46 and eight 50 by bolts 9.

Finally with reference to FIG. 5, a front plan view of a mounting plate 4 of a universal lug mounting bracket 2 of the present invention mounted to a six lug pattern having a short diameter between the lugs 3 is illustrated. The lugs 3 are mounted on slots one 36, two 38, four 42, five 44, six 46 and eight 50 by bolts 9.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A non-rotating wheel cover assembly having a universal lug mounting bracket for mounting a wheel cover to wheels having various lug patterns and wheel diameters, said non-rotating wheel cover assembly comprising:
at least two extended lug nuts, each having a first end and a second end;
said first end of each at least two extended lug nuts having a lug threaded aperture located therein for securing the at least two extended lug nuts to at least two lugs extending from a hub of a vehicle;
said second end of each at least two extended lug nuts having a bolt threaded aperture located therein;
a mounting plate having at least two slots located thereon through which at least two bolts are passed through to secure the mounting plate to the at least two extended lug nuts;
an aperture located in a center portion of the mounting plate;
an inner plate attached to a front surface of the mounting plate via an attachment means;
said inner plate having a hollow portion where a bearing having a central aperture is located;
an aperture located on a central portion of the front surface of the inner plate;
an outer plate having an axle extending from an rear surface of the outer plate thought the aperture located on the central portion of the inner plate and through the central aperture of the bearing; and
at least one threaded aperture located on the front surface of the outer plate for attaching a non-rotating wheel cover to the outer plate via at least one attachment means.

2. The non-rotating wheel cover assembly of claim 1 wherein:
said mounting plate has eight slots located thereon.

3. The non-rotating wheel cover assembly of claim 2 wherein said eight slots comprises:
a first slot is at an angle of 0 degrees in relation to a center of the mounting plate and a top of the mounting plate;
a second slot is at an angle of 60 degrees in relation to the first slot;
a third slot is at an angle of 90 degrees in relation to the first slot;
a fourth slot is at an angle of 145 degrees in relation to the first slot;
a fifth slot is at an angle of 180 degrees in relation to the first slot;
a sixth slot is at an angle of 215 degree in relation to the first slot;
a seventh slot is at an angle of 270 degrees in relation to the first slot; and
an eighth slot at an angle of 300 degree in relation to the first slot.

4. The non-rotating wheel cover assembly of claim 1 further comprising:
a ridge located at a base of the axle for maintaining a predetermined distance between the inner plate and the outer plate.

5. The non-rotating wheel cover assembly of claim 1 further comprising:
at least two posts located on a rear surface of the non-rotating wheel cover that engage at least two apertures located on the front surface of the outer plate, thereby aligning the non-rotating wheel cover on the outer plate for easy installation.

6. The non-rotating wheel cover assembly of claim 1 further comprising:
a weight located on a rear surface of the non-rotating wheel cover.

7. A non-rotating wheel cover assembly having a universal lug mounting bracket for mounting a wheel cover to wheels having various lug patterns and wheel diameters, said non-rotating wheel cover assembly comprising:
at least two extended lug nuts, each having a first end and a second end;
said first end of each at least two extended lug nuts having a lug threaded aperture located therein for securing the at least two extended lug nuts to at least two lugs extending from a hub of a vehicle;
said second end of each at least two extended lug nuts having a bolt threaded aperture located therein;
a mounting plate having at least eight slots located thereon through which at least two bolts are passed through to secure the mounting plate to the at least two extended lug nuts;
an aperture located in a center portion of the mounting plate;
an inner plate attached to a front surface of the mounting plate via an attachment means;
said inner plate having a hollow portion where a bearing having a central aperture is located;
an aperture located on a central portion of the front surface of the inner plate;
an outer plate having an axle extending from an rear surface of the outer plate thought the aperture located on the central portion of the inner plate and through the central aperture of the bearing; and
at least one threaded aperture located on the front surface of the outer plate for attaching a non-rotating wheel cover to the outer plate via at least one attachment means.

8. The non-rotating wheel cover assembly of claim 7 wherein said at least eight slots comprises:
a first slot is at an angle of 0 degrees in relation to a center of the mounting plate and a top of the mounting plate;
a second slot is at an angle of 60 degrees in relation to the first slot;
a third slot is at an angle of 90 degrees in relation to the first slot;
a fourth slot is at an angle of 145 degrees in relation to the first slot;
a fifth slot is at an angle of 180 degrees in relation to the first slot;
a sixth slot is at an angle of 215 degree in relation to the first slot;
a seventh slot is at an angle of 270 degrees in relation to the first slot; and
an eighth slot at an angle of 300 degree in relation to the first slot.

9. The non-rotating wheel cover assembly of claim 7 further comprising:
a ridge located at a base of the axle for maintaining a predetermined distance between the inner plate and the outer plate.

10. The non-rotating wheel cover assembly of claim 7 further comprising:
at least two posts located on an rear surface of the non-rotating wheel cover that engage at least two apertures located on the front surface of the outer plate, thereby aligning the non-rotating wheel cover on the outer plate for easy installation.

11. The non-rotating wheel cover assembly of claim 7 further comprising:
a weight located on the rear surface of the non-rotating wheel cover.

12. A non-rotating wheel cover assembly having a universal lug mounting bracket for mounting a wheel cover to wheels having various lug patterns and wheel diameters, said non-rotating wheel cover assembly comprising:
at least two extended lug nuts, each having a first end and a second end;
said first end of each at least two extended lug nuts having a lug threaded aperture located therein for securing the at least two extended lug nuts to at least two lugs extending from a hub of a vehicle;
said second end of each at least two extended lug nuts having a bolt threaded aperture located therein;
a mounting plate having at least eight slots located thereon through which at least two bolts are passed through to secure the mounting plate to the at least two extended lug nuts;
an aperture located in a center portion of the mounting plate;
an inner plate attached to a front surface of the mounting plate via an attachment means;
said inner plate having a hollow portion where a bearing having a central aperture is located;
an aperture located on a central portion of the front surface of the inner plate;
an outer plate having an axle extending from an rear surface of the outer plate thought the aperture located on the central portion of the inner plate and through the central aperture of the bearing;
at least one threaded aperture located on the front surface of the outer plate for attaching a non-rotating wheel cover to the outer plate via at least one attachment means;
said at least eight slots having a first slot is at an angle of 0 degrees in relation to a center of the mounting plate and a top of the mounting plate;
said at least eight slots having a second slot is at an angle of 60 degrees in relation to the first slot;
said at least eight slots having a third slot is at an angle of 90 degrees in relation to the first slot;
said at least eight slots having a fourth slot is at an angle of 145 degrees in relation to the first slot;
said at least eight slots having a fifth slot is at an angle of 180 degrees in relation to the first slot;
said at least eight slots having a sixth slot is at an angle of 215 degree in relation to the first slot;
said at least eight slots having a seventh slot is at an angle of 270 degrees in relation to the first slot; and
said at least eight slots having an eighth slot at an angle of 300 degree in relation to the first slot.

13. The non-rotating wheel cover assembly of claim 12 further comprising:
a ridge located at a base of the axle for maintaining a predetermined distance between the inner plate and the outer plate.

14. The non-rotating wheel cover assembly of claim 12 further comprising:
at least two posts located on an rear surface of the non-rotating wheel cover that engage at least two apertures located on the front surface of the outer plate, thereby aligning the non-rotating wheel cover on the outer plate for easy installation.

15. The non-rotating wheel cover assembly of claim 12 further comprising:
a weight located on the rear surface of the non-rotating wheel cover.
